(19) United States
(12) Patent Application Publication
(10) Pub. No.: US 2017/0240020 A1
(43) Pub. Date: Aug. 24, 2017

(54) DAMPING AIR SPRING WITH ASYMMETRICALLY SHAPED ORIFICE

(71) Applicant: Hendrickson USA, L.L.C., Itasca, IL (US)

(72) Inventors: Damon Delorenzis, Plainfield, IL (US); James J. Patterson, North Canton, OH (US); Dmitriy Rubalskiy, Bolingbrook, IL (US)

(21) Appl. No.: 15/438,874

(22) Filed: Feb. 22, 2017

Related U.S. Application Data
(60) Provisional application No. 62/298,688, filed on Feb. 23, 2016.

(51) Int. Cl. B60G 17/048; F16F 9/04; F16F 9/34; B60G 17/052

(52) U.S. Cl. CPC B60G 17/0485; B60G 17/052; F16F 9/0472; F16F 9/049; F16F 9/34; B60G 2202/242; B60G 2202/152; B60G 2300/026; F16F 2230/36

(57) ABSTRACT

An air spring with damping characteristics for a suspension assembly of a heavy-duty vehicle includes a bellows chamber, a piston chamber and an asymmetrical orifice. The asymmetrical orifice is in fluid communication with the bellows chamber and the piston chamber of the air spring. The asymmetrical orifice provides asymmetrical damping characteristics to the air spring of the heavy-duty vehicle.

### CROSS-REFERENCE TO RELATED APPLICATION

This application claims the benefit of U.S. Provisional Patent Application Ser. No. 62/298,688, filed on Feb. 23, 2016.

### BACKGROUND OF THE INVENTION

Field of the Invention

The invention relates generally to the art of axle/suspension systems for heavy-duty vehicles. More particularly, the invention relates to axle/suspension systems for heavy-duty vehicles which utilize an air spring to cushion the ride of the vehicle. More specifically, the invention is directed to an air spring with damping characteristics for a heavy-duty vehicle axle/suspension system, whereby the air spring utilizes an asymmetrically shaped orifice to promote asymmetrical damping of the axle/suspension system in order to improve application specific ride quality for the heavy-duty vehicle during operation.

Background Art

The use of air-ride trailing and leading arm rigid beam-type axle/suspension systems has been very popular in the heavy-duty truck and tractor-trailer industry for many years. Although such axle/suspension systems are found in widely varying structural forms, in general their structure is similar in that each system typically includes a pair of suspension assemblies. In some heavy-duty vehicles, the suspension assemblies are connected directly to the primary frame of the vehicle. In other heavy-duty vehicles, the primary frame of the vehicle supports a subframe, and the suspension assemblies connect directly to the subframe. For those heavy-duty vehicles that support a subframe, the subframe can be non-movable or movable, the latter being commonly referred to as a slider box, slider subframe, slider undercarriage, or secondary slider frame. For the purpose of convenience and clarity, reference herein will be made to main members, with the understanding that such reference is by way of example, and that the present invention applies to heavy-duty vehicle axle/suspension systems suspended from main members of: primary frames, movable subframes and non-movable subframes.

Specifically, each suspension assembly of an axle/suspension system includes a longitudinally extending elongated beam. Each beam typically is located adjacent to and below a respective one of a pair of spaced-apart longitudinally extending main members and one or more cross members, which form the frame of the vehicle. More specifically, each beam is pivotally connected at one of its ends to a hanger, which in turn is attached to and depends from a respective one of the main members of the vehicle. An axle extends transversely between and typically is connected by some means to the beams of the pair of suspension assemblies at a selected location from about the mid-point of each beam to the end of the beam opposite from its pivotal connection end. The beam end opposite the pivotal connection end also is connected to an air spring, or other spring mechanism, which in turn is connected to a respective one of the main members. A height control valve is mounted on the main member or other support structure and is operatively connected to the beam and to the air spring in order to maintain the ride height of the vehicle. A brake system and, optionally, one or more shock absorbers for providing damping to the axle/suspension system of the vehicle also are mounted on the axle/suspension system. The beam may extend rearwardly or frontwardly from the pivotal connection relative to the front end of the vehicle, thus defining what are typically referred to as trailing arm or leading arm axle/suspension systems, respectively. However, for purposes of the description contained herein, it is understood that the term “trailing arm” will encompass beams which extend either rearwardly or frontwardly with respect to the front end of the vehicle.

The axle/suspension systems of the heavy-duty vehicle act to cushion the ride, dampen vibrations and stabilize the vehicle. More particularly, as the vehicle is traveling over the road, its wheels encounter road conditions that impart various forces, loads, and/or stresses, collectively referred to herein as forces, to the respective axle on which the wheels are mounted, and in turn, to the suspension assemblies that are connected to and support the axle. In order to minimize the detrimental effect of these forces on the vehicle as it is operating, the axle/suspension system is designed to react and/or absorb at least some of them.

These forces include vertical forces caused by vertical movement of the wheels as they encounter certain road conditions, fore-aft forces caused by acceleration and deceleration of the vehicle as well as certain road conditions, and side-load and torsional forces associated with transverse vehicle movement, such as turning of the vehicle and lane-change maneuvers. In order to address such disparate forces, axle/suspension systems have differing structural requirements. More particularly, it is desirable for an axle/suspension system to have beams that are fairly stiff in order to minimize the amount of sway experienced by the vehicle and thus provide what is known in the art as roll stability. However, it is also desirable for an axle/suspension system to be relatively flexible to assist in cushioning the vehicle from vertical impacts, and to provide compliance so that the components of the axle/suspension system resist failure, thereby increasing durability of the axle/suspension system. It is also desirable to dampen the vibrations or oscillations that result from such forces. A key component of the axle/suspension system that cushions the ride of the vehicle from vertical impacts is the air spring. In the past, a shock absorber was utilized on the axle/suspension system to provide damping characteristics to the axle/suspension system. More recently, air springs with damping characteristics have been developed that eliminate the shock absorber, and the air spring provides damping to the axle/suspension system. One such air spring with damping characteristics is shown and described in U.S. Pat. No. 8,540,222, owned by the assignee of the instant application, Hendrickson USA, L.L.C.

A conventional air spring without damping characteristics which is utilized in heavy-duty air-ride axle/suspension systems includes three main components: a flexible bellows, a piston and a bellows top plate. The bellows is typically formed from rubber or other flexible material, and is operatively mounted on top of the piston. The piston is typically formed from steel, aluminum, fiber reinforced plastics or other rigid material, and is mounted on the rear end of the top plate of the beam of the suspension assembly by fasteners of the type that are generally well known in the art. The volume of pressurized air, or “air volume”, that is contained within the air spring is a major factor in determining the spring rate of the air spring. More specifically, this air volume is contained within the bellows and, in some cases, the piston of the air spring. The larger the air volume of the air spring, the lower the spring rate of the air spring. A lower spring rate is generally more desirable in the heavy-duty vehicle industry because it provides a softer ride to the vehicle during operation.

Prior art air springs without damping characteristics, while providing cushioning to the vehicle cargo and occupant(s) during operation of the vehicle, provide little, if any, damping characteristics to the axle/suspension system. Such damping characteristics are instead typically provided by a pair of hydraulic shock absorbers, although a single shock absorber has also been utilized and is generally well known in the art. Each one of the shock absorbers is mounted on and extends between the beam of a respective one of the suspension assemblies of the axle/suspension system and a respective one of the main members of the vehicle. These shock absorbers add complexity and weight to the axle/suspension system. Moreover, because the shock absorbers are a service item of the axle/suspension system that will require maintenance and/or replacement from time to time, they also add additional maintenance and/or replacement costs to the axle/suspension system.

The amount of cargo that a vehicle may carry is governed by local, state, and/or national road and bridge laws. The basic principle behind most road and bridge laws is to limit the maximum load that a vehicle may carry, as well as to limit the maximum load that can be supported by individual axles. Because shock absorbers are relatively heavy, these components add undesirable weight to the axle/suspension system and therefore reduce the amount of cargo that can be carried by the heavy-duty vehicle. Depending on the shock absorbers employed, they also add varying degrees of complexity to the axle/suspension system, which is also undesirable.

An air spring with damping characteristics, such as the one shown and described in U.S. Pat. No. 8,540,222, owned by the assignee of the instant application, Hendrickson USA, L.L.C., includes a piston having a hollow cavity which is in fluid communication with the bellows via at least one opening, which provides restricted communication of air between the piston and the bellows volumes during operation of the axle/suspension system. The air volume of the air spring is in fluid communication with the height control valve of the vehicle, which in turn is in fluid communication with an air source, such as an air supply tank. The height control valve, by directing airflow into and out of the air spring of the axle/suspension system, helps maintain the desired ride height of the vehicle.

The restricted communication of air between the piston chamber and the bellows chamber during operation provides damping to the axle/suspension system. More specifically, when the axle/suspension system experiences a jounce event, such as when the vehicle wheels encounter a curb or a raised bump in the road, the axle moves vertically upwardly toward the vehicle chassis. In such a jounce event, the bellows chamber is compressed by the axle/suspension system as the wheels of the vehicle travel over the curb or the raised bump in the road. The compression of the air spring bellows chamber causes the internal pressure of the bellows chamber to increase. Therefore, a pressure differential is created between the bellows chamber and the piston chamber. This pressure differential causes air to flow from the bellows chamber through the opening(s) into the piston chamber. Air will flow back and forth through the opening(s) between the bellows chamber and the piston chamber until the pressures of the piston chamber and the bellows chamber have equalized. The restricted flow of air back and forth through the opening(s) causes damping to occur.

Conversely, when the axle/suspension system experiences a rebound event, such as when the vehicle wheels encounter a large hole or depression in the road, the axle moves vertically downwardly away from the vehicle chassis. In such a rebound event, the bellows chamber is expanded by the axle/suspension system as the wheels of the vehicle travel into the hole or depression in the road. The expansion of the air spring bellows chamber causes the internal pressure of the bellows chamber to decrease. As a result, a pressure differential is created between the bellows chamber and the piston chamber. This pressure differential causes air to flow from the piston chamber through the opening(s) into the bellows chamber. Air will continue to flow back and forth through the opening(s) between the bellows chamber and the piston chamber until the pressures of the piston chamber and the bellows chamber have equalized. The restricted flow of air back and forth through the opening(s) causes damping to occur.

Prior art air springs having damping characteristics, while satisfactorily performing their intended function, have certain limitations due to their structural make-up. For example, because the prior art air springs only include openings that are formed at right angles to the piston chamber, thus forming a blunt 90 degree edge at the bellows chamber and the piston chamber, the damping provided by the air spring is typically symmetrical with respect to jounce and rebound. In other words, the amount of damping provided by the air spring is the same for a jounce event as it is for a rebound event. The symmetrical damping exhibited by the prior art damping air spring, reduces the ability to tune the damping of the air spring for a given application, because increasing or decreasing damping for a jounce event will also result in increasing or decreasing damping for a rebound event, and vice versa, which may not be desired by the vehicle manufacturer. Therefore, it is desirable to have an air spring with asymmetrical damping features that enables it to have less damping in a jounce event, yet more damping in a rebound event, or vice-versa, thereby allowing the damping air spring to be tuned in order to improve application specific ride quality for the heavy-duty vehicle during operation.

The damping air spring with an asymmetrically shaped orifice of the present invention overcomes the problems associated with prior art air springs with and without damping features, by providing an orifice that is asymmetrically shaped and which is capable of providing improved airflow control, resulting in asymmetrical damping characteristics of the air spring. By providing an air spring for heavy-duty vehicles having asymmetrical damping characteristics, the shock absorber of the axle/suspension system can be eliminated or its size reduced, reducing complexity, saving weight and cost, and allowing the heavy-duty vehicle to haul more cargo. Moreover, elimination of the shock absorbers potentially eliminates costly repairs and/or maintenance costs associated with these systems.

The damping air spring with asymmetrically shaped orifice of the present invention provides asymmetrical airflow between the bellows chamber and the piston chamber, which results in asymmetrical damping of the air spring to improve application specific ride quality for the heavy-duty vehicle during operation.

### SUMMARY OF THE INVENTION

An objective of the damping air spring with asymmetrically shaped orifice of the present invention includes providing a damping air spring for heavy-duty vehicles that provides asymmetrical damping features to the axle/suspension system, thereby improving the ability to tune the damping of the air spring for a given application.

A further objective of the damping air spring with asymmetrically shaped orifice of the present invention is to provide a damping air spring for heavy-duty vehicles that provides improved airflow control between the bellows chamber and the piston chamber of the air spring.

Yet another objective of the damping air spring with asymmetrically shaped orifice of the present invention is to provide a damping air spring for heavy-duty vehicles that reduces or eliminates the need for a shock absorber, thereby reducing complexity, saving weight and cost, and allowing the heavy-duty vehicle to haul more cargo.

These objectives and advantages are obtained by the damping air spring with asymmetrically shaped orifice for a heavy-duty vehicle of the present invention, which includes a bellows including a bellows chamber; a piston including a piston chamber; and an asymmetrical orifice in fluid communication with the bellows chamber and the piston chamber, wherein the asymmetrical orifice provides asymmetrical damping characteristics to the air spring of the heavy-duty vehicle.

### BRIEF DESCRIPTION OF THE SEVERAL VIEWS OF THE DRAWINGS

The preferred embodiments of the present invention, illustrative of the best mode in which applicants have contemplated applying the principles, are set forth in the following description and shown in the drawings, and are particularly and distinctly pointed out and set forth in the appended claims.

FIG. 1 is a top rear driver side perspective view of an axle/suspension system incorporating a pair of prior art non-damping air springs, and showing a pair of shock absorbers, with each one of the pair of shock absorbers mounted on a respective one of the suspension assemblies of the axle/suspension system;

FIG. 2 is a perspective view, in section, of a prior art air spring with damping characteristics, showing the bellows chamber in fluid communication with the piston chamber via a pair of openings;

FIG. 2A is a graphical representation of the symmetrical damping curve of the prior art damping air spring shown in FIG. 2;

FIG. 3 is a perspective view, in section, of a first exemplary embodiment damping air spring utilizing an asymmetrically shaped orifice of the present invention, showing the asymmetrically shaped orifice formed through the air spring retaining plate and the top plate of the air spring piston, in order to allow fluid communication between a bellows chamber of the air spring and a piston chamber of the air spring to provide damping to the air spring during operation of the vehicle;

FIG. 4 is a greatly enlarged fragmentary view of a portion of FIG. 3, showing the asymmetrically shaped orifice formed through the air spring retaining plate and the top plate of the air spring piston, in order to allow fluid communication between the bellows chamber and the piston chamber of the air spring, to provide damping to the air spring during operation of the vehicle;

FIG. 4A is a graphical representation of the damping curve of the first exemplary embodiment damping air spring utilizing an asymmetrically shaped orifice of the present invention shown in FIG. 4, with the conical portion formed in the retaining plate and the cylindrical portion formed in the piston top plate;

FIG. 4B is a graphical representation of the damping curve of the first exemplary embodiment damping air spring utilizing an alternatively arranged asymmetrically shaped orifice shown in FIG. 4C;

FIG. 4C is a view similar to FIG. 4, but showing an alternate configuration for the asymmetrical orifice with the conical portion formed in the piston top plate and the cylindrical portion formed in the retaining plate;

FIG. 5 is a perspective view, in section, of a first alternate configuration of the first exemplary embodiment damping air spring with asymmetrically shaped orifice of the present invention, showing the asymmetrically shaped orifice formed through the air spring retaining plate and the top plate of the air spring piston, in order to allow fluid communication between the bellows chamber and the piston chamber of the air spring to provide damping to the air spring during operation of the vehicle;

FIG. 6 is a greatly enlarged fragmentary view of a portion of FIG. 5, showing the asymmetrically shaped orifice formed through the air spring retaining plate and the top plate of the air spring piston, in order to allow fluid communication between the bellows chamber and the piston chamber of the air spring to provide damping to the air spring during operation of the vehicle;

FIG. 7 is perspective view, in section, of a second alternate configuration of the first exemplary embodiment damping air spring with asymmetrically shaped orifice of the present invention, showing the asymmetrically shaped orifice formed through the air spring retaining plate and the top plate of the air spring piston, in order to allow fluid communication between a bellows chamber and a piston chamber of the air spring to provide damping to the air spring during operation of the vehicle;

FIG. 8 is a greatly enlarged fragmentary view of a portion of FIG. 7, showing the asymmetrically shaped orifice formed through the air spring retaining plate and the top plate of the air spring piston, in order to allow fluid communication between the bellows chamber and the piston chamber of the air spring to provide damping to the air spring during operation of the vehicle;

FIG. 9 is a perspective view, in section, of a second exemplary embodiment damping air spring with asymmetrically shaped orifice of the present invention, showing the asymmetrically shaped orifice formed through the air spring retaining plate and the top plate of the air spring piston, in order to allow fluid communication between a bellows chamber and a piston chamber of the air spring to provide damping to the air spring during operation of the vehicle;

FIG. 10 is a greatly enlarged fragmentary view of a portion of FIG. 9, showing the asymmetrically shaped orifice formed through the air spring retaining plate and the top plate of the air spring piston, in order to allow fluid communication between the bellows chamber and the piston chamber of the air spring to provide damping to the air spring during operation of the vehicle; and

FIG. 11 is a view similar to FIG. 10, but showing an alternate configuration for the asymmetrical orifice with the radiused portion formed in the piston top plate and the cylindrical portion formed in the retaining plate.

Similar numerals refer to similar parts throughout the drawings.

### DESCRIPTION OF THE PREFERRED EMBODIMENT

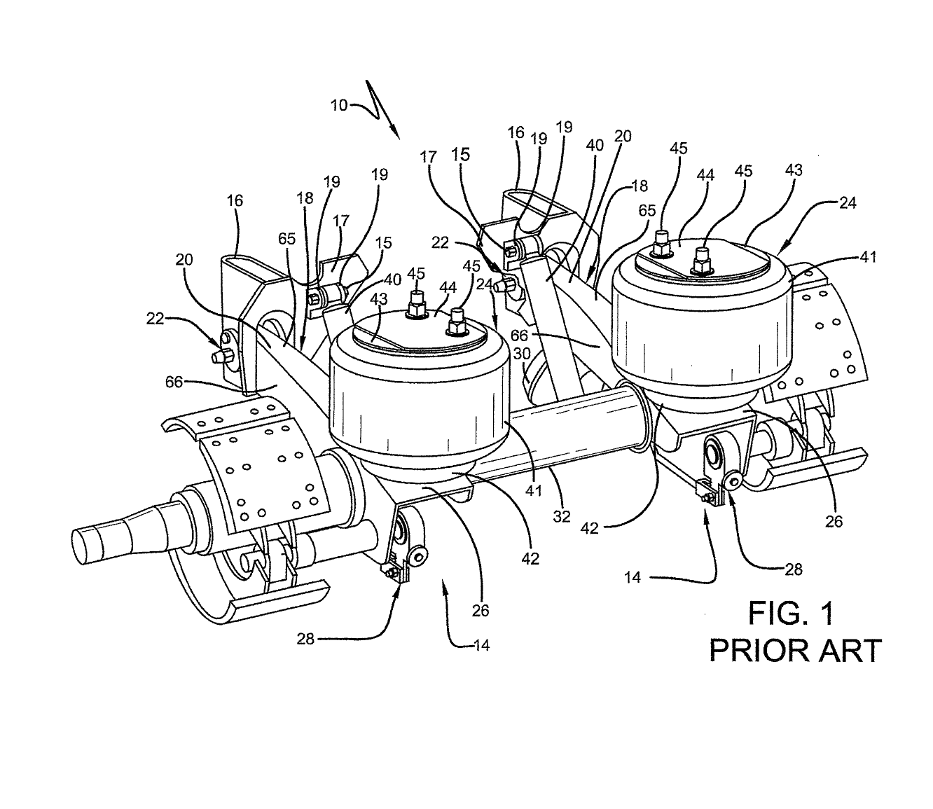

In order to better understand the environment in which the air spring with damping characteristics for a heavy-duty vehicle of the present invention is utilized, a trailing arm overslung beam-type air-ride axle/suspension system that incorporates a pair of prior art air springs 24 without damping characteristics, is indicated generally at 10, is shown in FIG. 1, and now will be described in detail below.

It should be noted that axle/suspension system 10 is typically mounted on a pair of longitudinally-extending spaced-apart main members (not shown) of a heavy-duty vehicle, which is generally representative of various types of frames used for heavy-duty vehicles, including primary frames that do not support a subframe and primary frames and/or floor structures that do support a subframe. For primary frames and/or floor structures that do support a subframe, the subframe can be non-movable or movable, the latter being commonly referred to as a slider box. Because axle/suspension system 10 generally includes an identical pair of suspension assemblies 14, for sake of clarity and conciseness only one of the suspension assemblies will be described below.

Suspension assembly 14 is pivotally connected to a hanger 16 via a trailing arm overslung beam 18. More specifically, beam 18 is formed having a generally upside-down integrally formed U-shape with a pair of sidewalls 66 and a top plate 65, with the open portion of the beam facing generally downwardly. A bottom plate (not shown) extends between and is attached to the lowermost ends of sidewalls 66 by any suitable means such as welding to complete the structure of beam 18. Trailing arm overslung beam 18 includes a front end 20 having a bushing assembly 22, which includes a bushing, pivot bolts and washers as are well known in the art, to facilitate pivotal connection of the beam to hanger 16. Beam 18 also includes a rear end 26, which is welded or otherwise rigidly attached to a transversely extending axle 32.

Suspension assembly 14 also includes air spring 24, mounted on and extending between beam rear end 26 and the main member (not shown). Air spring 24 includes a bellows 41 and a piston 42. The top portion of bellows 41 is sealingly engaged with a bellows top plate 43. With continued reference to FIG. 1, an air spring mounting plate 44 is mounted on top plate 43 by fasteners 45, which are also used to mount the top portion of air spring 24 to the vehicle main member (not shown). Piston 42 is generally cylindrical-shaped and has a generally flat bottom plate and top plate (not shown). The bottom portion of the bellows 41 is sealingly engaged with the piston top plate (not shown). The piston bottom plate rests on beam top plate 65 at beam rear end 26 and is attached thereto in a manner well known to those having skill in the art, such as by fasteners or bolts (not shown). The piston top plate is formed without openings so that there is no fluid communication between piston 42 and bellows 41. As a result, piston 42 does not generally contribute any appreciable volume to air spring 24. The top end of a shock absorber 40 is mounted on an inboardly extending wing 17 of hanger 16 via a mounting bracket 19 and a fastener 15, in a manner well known in the art. The bottom end of shock absorber 40 is mounted to beam 18 (the mount not shown) in a manner well known to those having skill in the art. For the sake of relative completeness, a brake system 28 including a brake chamber 30 is shown mounted on prior art suspension assembly 14.

As mentioned above, axle/suspension system 10 is designed to absorb forces that act on the vehicle as it is operating. More particularly, it is desirable for axle/suspension system 10 to be rigid or stiff in order to resist roll forces and thus provide roll stability for the vehicle. This is typically accomplished by using beam 18, which is rigid, and also is rigidly attached to axle 32. It is also desirable, however, for axle/suspension system 10 to be flexible to assist in cushioning the vehicle (not shown) from vertical impacts and to provide compliance so that the axle/suspension system resists failure. Such flexibility typically is achieved through the pivotal connection of beam 18 to hanger 16 with bushing assembly 22. Air spring 24 cushions the ride for cargo and passengers while shock absorber 40 controls the ride for cargo and passengers.

Prior art air spring 24 described above, has very limited or no damping capabilities because its structure, as described above, does not provide for the same. Instead, prior art air spring 24 relies on shock absorber 40 to provide damping to axle/suspension system 10.

Because shock absorber 40 is relatively heavy, this adds weight to axle/suspension system 10 and therefore reduces the amount of cargo that can be carried by the heavy-duty vehicle. Shock absorbers 40 also add complexity to axle/suspension system 10. Moreover, because shock absorbers 40 are a service item of axle/suspension system 10 that will require maintenance and/or replacement from time to time, they also add additional maintenance and/or replacement costs to the axle/suspension system.

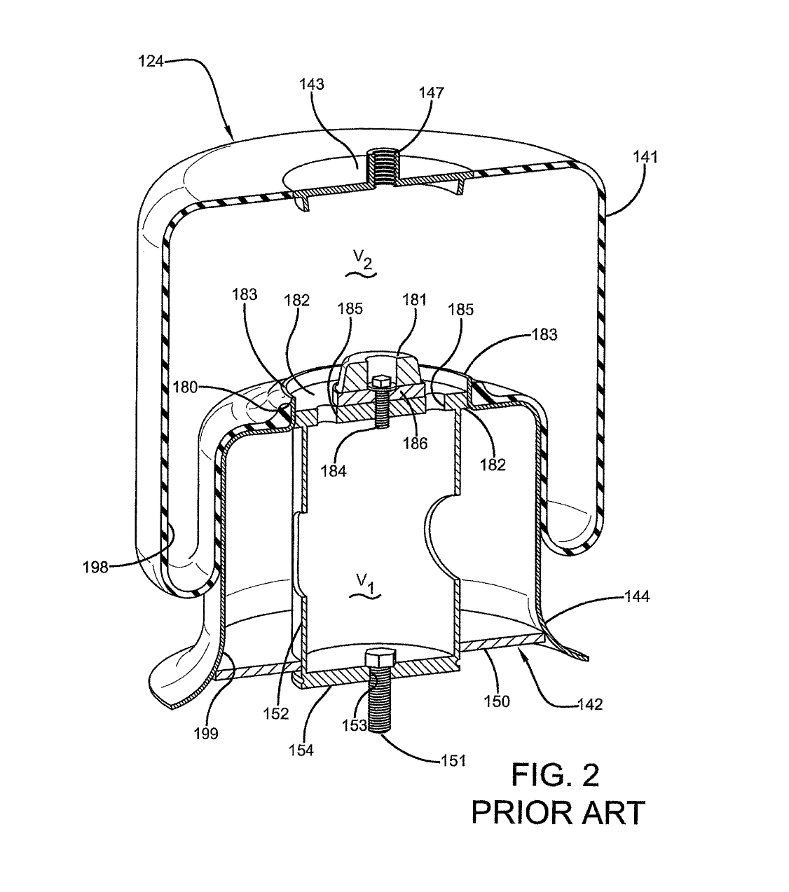

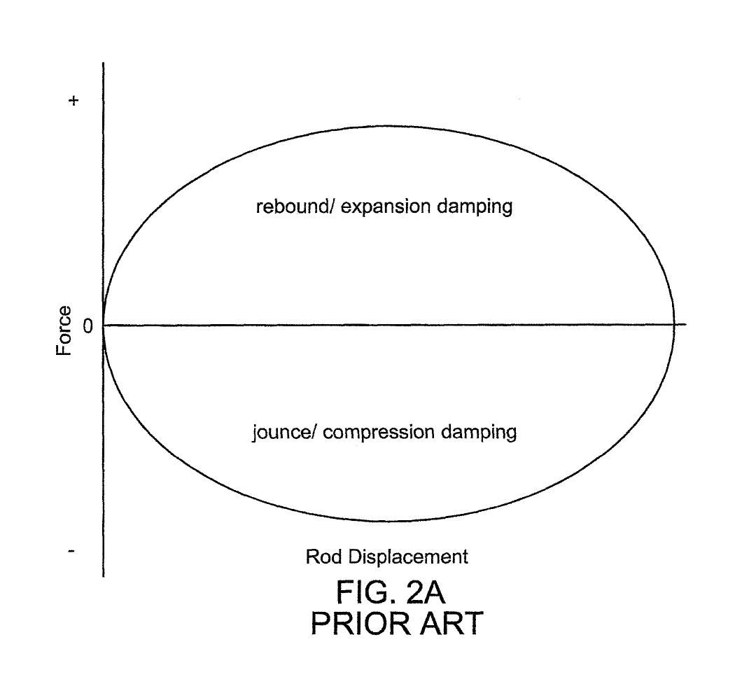

A prior art air spring with damping features is shown in FIG. 2 at reference numeral 124. Like prior art air spring 24, prior art air spring 124 is incorporated into an axle/suspension system similar to axle/suspension system 10, or other similar air-ride axle/suspension system, but typically without shock absorbers. Air spring 124 includes a bellows 141 and a piston 142. The top end of bellows 141 is sealingly engaged with a bellows top plate 143 in a manner well known in the art. An air spring mounting plate (not shown) is mounted on the top surface of top plate 143 by a fastener 147 which is also used to mount the top portion of air spring 124 to a respective one of the main members (not shown) of the vehicle. Alternatively, bellows top plate 143 could also be mounted directly on a respective one of the main members (not shown) of the vehicle. Piston 142 is generally cylindrical-shaped and includes a continuous generally stepped sidewall 144 attached to a generally flat bottom plate 150, and includes a top plate 182. Bottom plate 150 is formed with an upwardly extending central hub 152. Central hub 152 includes a bottom plate 154 formed with a central opening 153. A fastener 151 is disposed through opening 153 in order to attach piston 142 to the beam top plate (not shown) at beam rear end (not shown). Top plate 182, sidewall 144 and bottom plate 150 of piston 142 define a piston chamber 199 having an interior volume V₁. Top plate 182 of piston 142 is formed with a circular upwardly extending protrusion 183 having a lip 180 around its circumference. Lip 180 cooperates with the lowermost end of bellows 141 to form an airtight seal between the bellows and the lip, as is well known to those of ordinary skill in the art. Bellows 141, top plate 143 and piston top plate 182 define a bellows chamber 198 having an interior volume V₂ at standard static ride height. A bumper 181 is rigidly attached to a bumper mounting plate 186 by means generally well known in the art. Bumper mounting plate 186 is in turn mounted on piston top plate 182 by a fastener 184. Bumper 181 extends upwardly from the top surface of bumper mounting plate 186. Bumper 181 serves as a cushion between piston top plate 182 and bellows top plate 143 in order to keep the plates from contacting one another during operation of the vehicle, which can potentially cause damage to the plates and air spring 124.

Piston top plate 182 is formed with a pair of openings 185, which allow volume V₁ of piston chamber 199 and volume V₂ of bellows chamber 198 to communicate with one another. More particularly, openings 185 allow fluid or air to pass between piston chamber 199 and bellows chamber 198 during operation of the vehicle. Openings 185 are circular shaped and are generally perpendicular to the top and bottom surfaces of the piston top plate.

The ratio of the cross-sectional area of openings 185 measured in in.² to the volume of piston chamber 199 measured in in.³ to the volume of bellows chamber 198 measured in in.³ is in the range of ratios of from about 1:600:1200 to about 1:14100:23500. The range of ratios set forth above is an inclusive range of ratios that could be alternatively expressed as 1:600-14100:1200-23500, including any combination of ratios in between, and, for example, would necessarily include the following ratios: 1:600:23500 and 1:14100:1200.

By way of example, air spring 124 for axle/suspension system 10 for a heavy-duty trailer having an axle GAWR of about 20,000 lbs., utilizes bellows chamber 198 having volume V₂ equal to about 485 in.³, piston chamber 199 having volume V₁ of about 240 in.³, and openings 185 having a combined cross-sectional area of about 0.06 in.².

Having now described the structure of air spring 124, the operation of the damping characteristics of the air spring will be described in detail below. When axle 32 of axle/suspension system 10 experiences a jounce event, such as when the vehicle wheels encounter a curb or a raised bump in the road, the axle moves vertically upwardly toward the vehicle chassis. In such a jounce event, bellows chamber 198 is compressed by axle/suspension system 10 as the wheels of the vehicle travel over the curb or the raised bump in the road. The compression of air spring bellows chamber 198 causes the internal pressure of the bellows chamber to increase. As a result, a pressure differential is created between bellows chamber 198 and piston chamber 199. This pressure differential causes air to flow from bellows chamber 198, through piston top plate openings 185 and into piston chamber 199. The restricted flow of air between bellows chamber 198 into piston chamber 199 through piston top plate openings 185 causes damping to occur. As an additional result of the airflow through openings 185, the pressure differential between bellows chamber 198 and piston chamber 199 is reduced. Air continues to flow through piston top plate openings 185 until the pressures of piston chamber 199 and bellows chamber 198 have equalized. When little or no suspension movement has occurred over a period of several seconds the pressure of bellows chamber 198 and piston chamber 199 can be considered equal.

Conversely, when axle 32 of axle/suspension system 10 experiences a rebound event, such as when the vehicle wheels encounter a large hole or depression in the road, the axle moves vertically downwardly away from the vehicle chassis. In such a rebound event, bellows chamber 198 is expanded by axle/suspension system 10 as the wheels of the vehicle travel into the hole or depression in the road. The expansion of air spring bellows chamber 198 causes the internal pressure of the bellows chamber to decrease. As a result, a pressure differential is created between bellows chamber 198 and piston chamber 199. This pressure differential causes air to flow from piston chamber 199, through piston top plate openings 185, and into bellows chamber 198. The restricted flow of air through piston top plate openings 185 between piston chamber 199 into bellows chamber 198 causes damping to occur. As an additional result of the airflow through openings 185, the pressure differential between the bellows chamber 198 and piston chamber 199 is reduced. Air will continue to flow through the piston top plate openings 185 until the pressures of piston chamber 199 and bellows chamber 198 have equalized. When little or no suspension movement has occurred over a period of several seconds the pressure of bellows chamber 198 and piston chamber 199 can be considered equal.

As described above, volume V₁ of piston chamber 199, volume V₂ of bellows chamber 198, along with the cross-sectional area of openings 185, all in relation to one another, provide limited application-specific damping characteristics, at standard temperature and pressure, to air spring 124 during operation of the vehicle.

Prior art air spring 124 with damping characteristics, although satisfactorily performing its intended damping function, has certain constraints due to its structural make-up. For example, because prior art air spring 124 only includes openings 185 that are generally perpendicular to the top and bottom surfaces of piston top plate 182 located between bellows chamber 198 and piston chamber 199, the damping provided by the air spring is symmetrical, meaning that the amount of damping provided during expansion or rebound is the same as the amount of damping provided during compression or jounce, as shown in FIG. 2A. The symmetrical damping exhibited by prior art damping air spring 124 reduces the ability to tune the damping of the air spring for a given application, because increasing or decreasing damping for a jounce event will also result in increasing or decreasing damping for a rebound event, and vice versa, which may not be desired by the vehicle manufacturer.

The damping air spring with asymmetrically shaped orifice of the present invention overcomes the limitations of prior art non-damping and damping air springs 24, 124 described above, and will now be described in detail below.

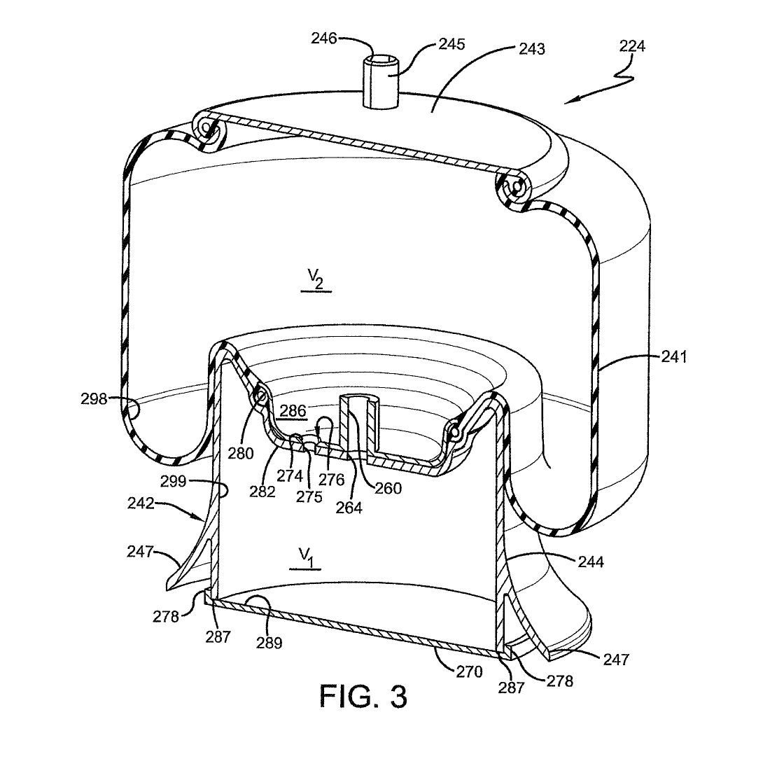

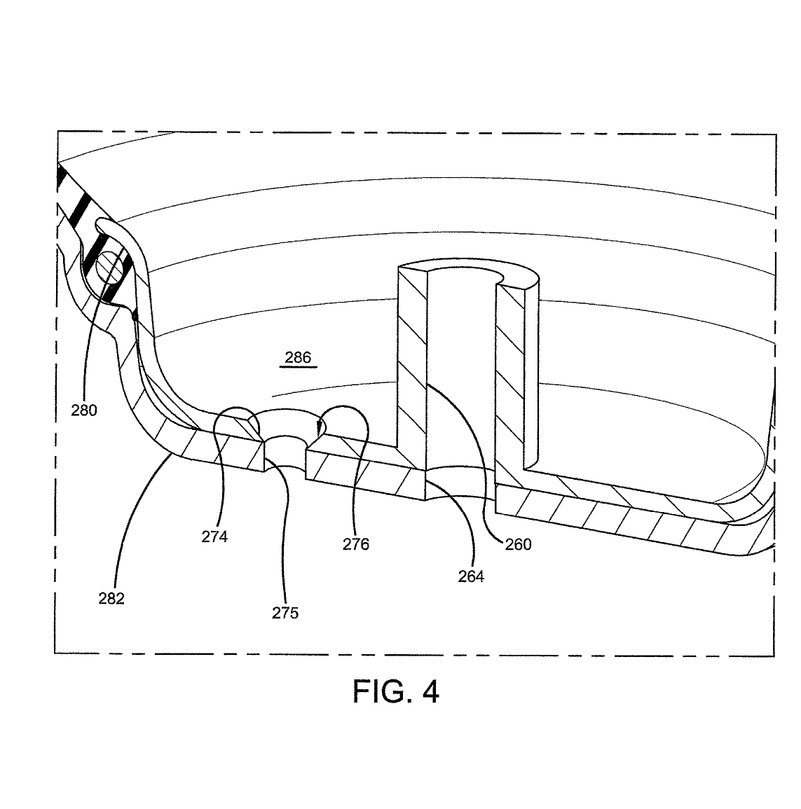

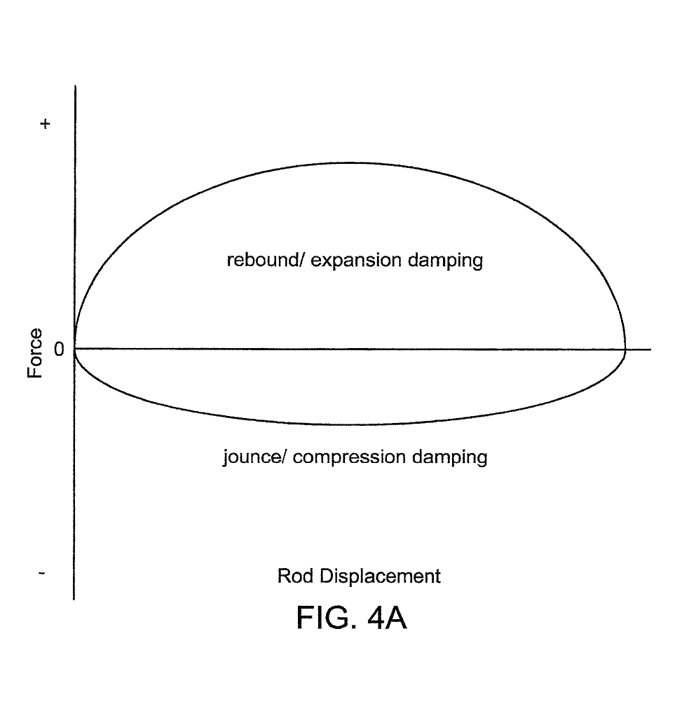

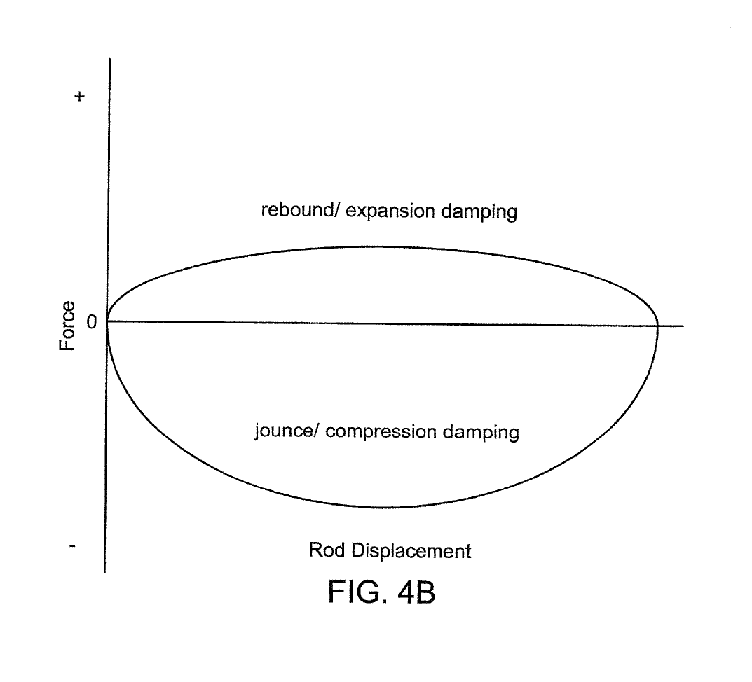

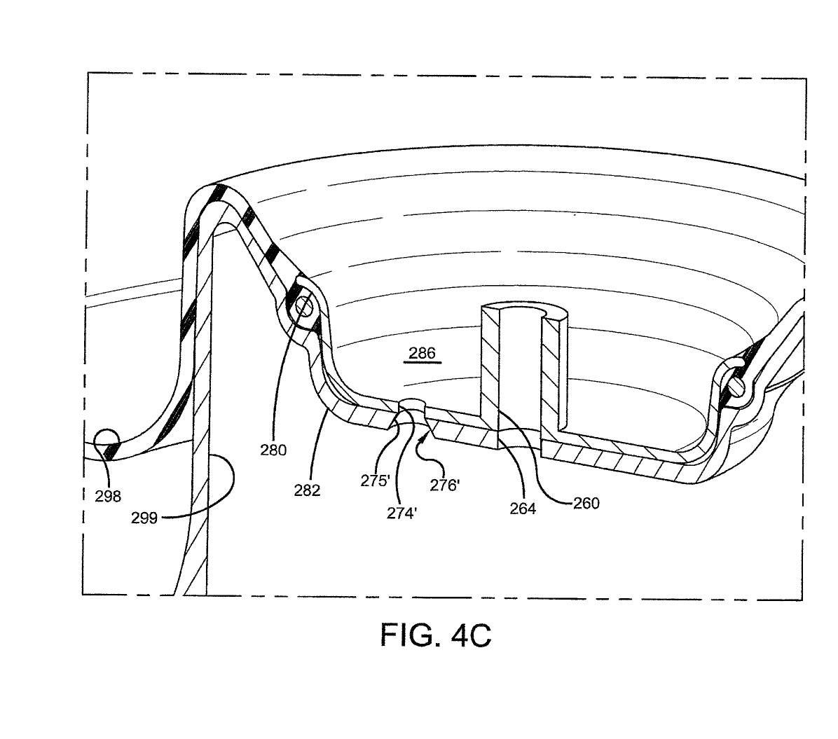

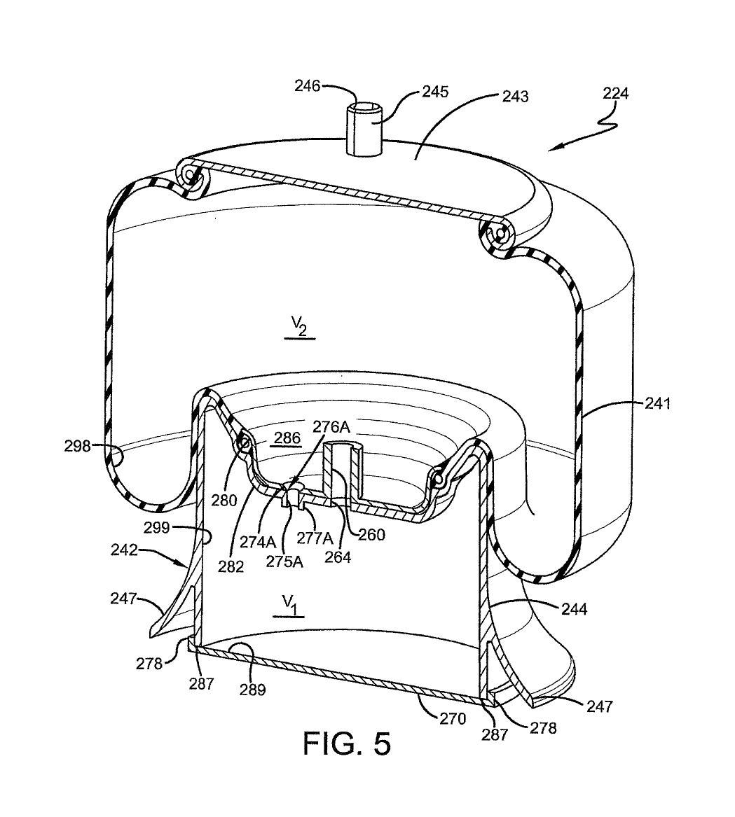

A first exemplary embodiment damping air spring with asymmetrically shaped orifice of the present invention is shown in FIGS. 3-4 at reference numeral 224, and will now be described in detail below. Alternate configurations of the asymmetrically shaped orifice of first exemplary embodiment damping air spring 224 of the present invention are shown in FIGS. 5-6 and 7-8, and will also be described in detail below.

Like prior art air springs 24 and 124, air spring 224 of the present invention is incorporated into an axle/suspension system having a structure similar to axle/suspension system 10, or other air-ride axle/suspension system, but typically without shock absorbers. Air spring 224 includes a bellows 241, a bellows top plate 243, and a piston 242. Top plate 243 includes a pair of fasteners 245 (only one shown), each formed with an opening 246. Fasteners 245 are utilized to mount air spring 224 to an air spring plate (not shown), that in turn is mounted to the main member of the vehicle (not shown). It should be understood that fasteners 245 could also be utilized to mount air spring 224 directly to the main member of the vehicle (not shown), without changing the overall concept or operation of the present invention. Piston 242 is generally cylindrical-shaped and includes a sidewall 244, a flared portion 247, and a top plate 282.

With particular reference to FIG. 3, a bumper (not shown) is disposed on a top surface of a retaining plate 286. The bumper (not shown) is formed from rubber, plastic or other compliant material and extends generally upwardly from retaining plate 286 mounted on the piston top plate 282. Retaining plate 286 and piston top plate 282 are each formed with an aligned opening 260,264, respectively. A fastener (not shown), such as a bolt, is disposed through an opening formed in the bumper (not shown), retaining plate opening 260, and piston top plate opening 264. The bumper (not shown) and retaining plate 286 are mounted on the top surface of piston top plate 282 by the fastener (not shown). The bumper (not shown) serves as a cushion between piston top plate 282 and the underside of bellows top plate 243 in order to prevent the plates from damaging one another during operation of the vehicle. Retaining plate 286 includes a flared end 280 that is molded into the lower end of bellows 241, which holds the bellows in place on piston 242 and forms an airtight seal between the bellows and the piston. It should be understood that flared end 280 of retaining plate 286 could also be separate from the lower end of bellows 241. In such an arrangement, separate flared end 280 captures and holds the lower end of bellows 241 in place on piston 242 to form an airtight seal between the bellows and the piston, without changing the overall concept or operation of the present invention. Bellows 241, retaining plate 286, and bellows top plate 243 generally define a bellows chamber 298 having an interior volume V₂ at standard ride height. Bellows chamber 298 preferably has a volume of from about 305 in.³ to about 915 in.³. More preferably, bellows chamber 298 has a volume of about 485 in.³.

A generally circular disc 270 is attached or mated to the bottom of piston 242 of first exemplary embodiment damping air spring 224 of the present invention. Circular disc 270 is formed with an opening (not shown) for fastening piston 242 to beam rear end top plate 65 (FIG. 1) directly or utilizing a beam mounting pedestal (not shown) in order to attach piston 242 of air spring 224 to beam 18 (FIG. 1). Once attached, a top surface 289 of circular disc 270 is mated to a lowermost surface 287 of piston sidewall 244 to provide an airtight seal between the circular disc and piston 242. Circular disc 270 is formed with a continuous raised lip 278 on its top surface along the periphery of the circular disc, with the continuous raised lip being disposed generally between flared portion 247 and sidewall 244 of piston 242 when the circular disc is mated to the piston. The attachment of circular disc 270 to piston 242 may be accomplished via fastening means such as a threaded fastener, other types of fasteners or the like. Optionally, the attachment of circular disc 270 to piston 242 may be supplemented by additional attachment means such as welding, soldering, crimping, friction welding, an O-ring, a gasket, adhesive or the like. Circular disc 270 may be composed of metal, plastic, and/or composite material, or other materials known to those skilled in the art, without changing the overall concept or operation of the present invention. Circular disc 270 may optionally include a groove (not shown) formed in top surface 289 disposed circumferentially around the circular disc, and configured to mate with a downwardly extending hub (not shown) of piston 242 in order to reinforce the connection of the disc to the bottom of the piston. An O-ring or gasket material could optionally be disposed in the groove to ensure an airtight fit of circular disc 270 to piston 242. Once circular disc 270 is attached to piston 242, top plate 282, sidewall 244, and the disc define a piston chamber 299 having an interior volume V₁. Piston chamber 299 is generally able to withstand the required burst pressure of axle/suspension system 10 (FIG. 1) during vehicle operation. Piston chamber 299 preferably has a volume of from about 150 in.³ to about 550 in.³. More preferably, piston chamber 299 has a volume of about 240 in.³.

Turning now to FIG. 4 and in accordance with one of the primary features of the present invention, a conical-shaped or chamfered opening 274 is formed in retaining plate 286 and is continuous with an aligned cylindrical opening 275 formed in top plate 282 of piston 242. Openings 274, 275 have a horizontal cross section with a generally circular shape but may have other shapes including oval, elliptical, polygonal or other shapes without changing the overall concept or operation of the present invention. Alternate configurations or arrangements of openings 274, 275 are shown in FIGS. 5 and 6 and FIGS. 7 and 8, respectively. Openings 274 and 275 cooperate to form a continuous asymmetrically shaped orifice 276.

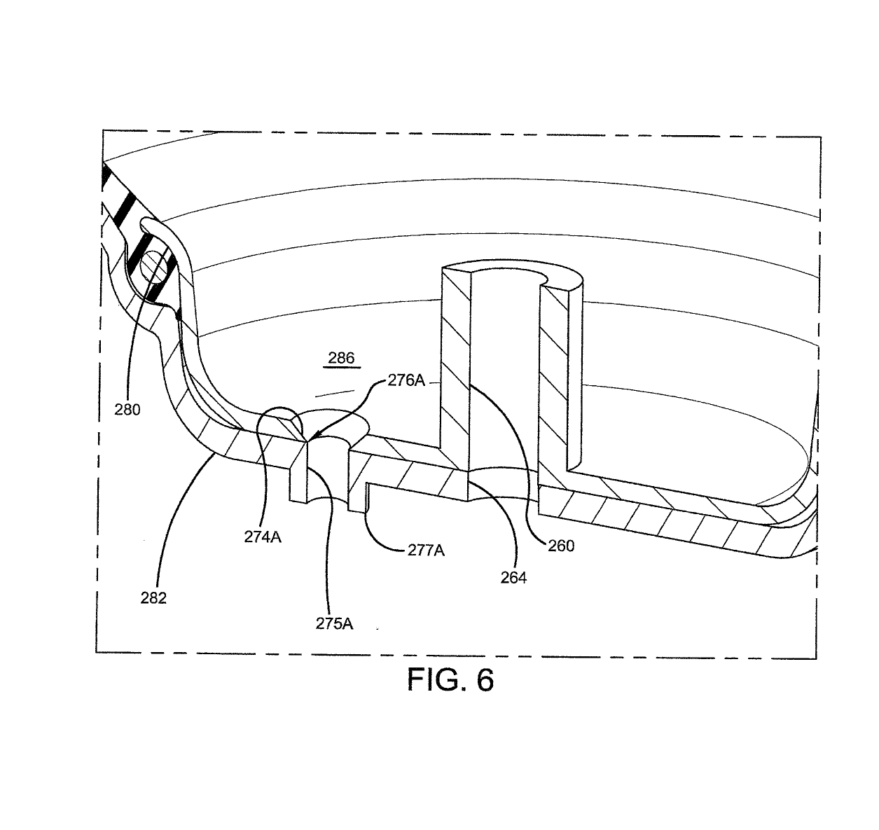

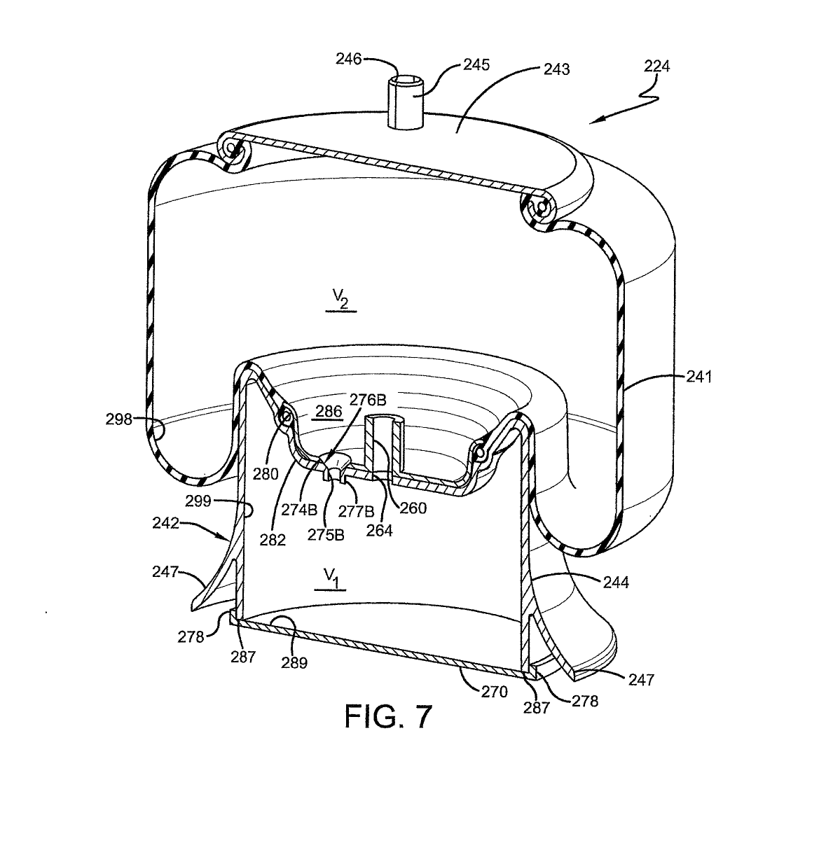

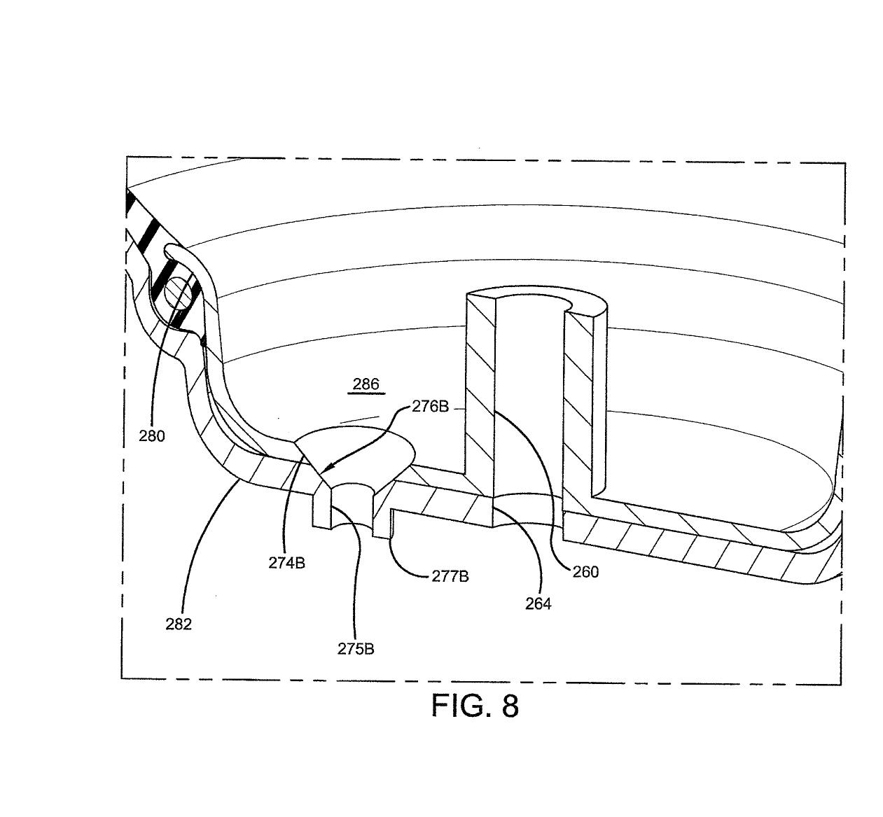

Turning now to FIGS. 5 and 6, first embodiment air spring 224 of the present invention is shown with alternatively configured or arranged openings. A conical shaped opening 274A is formed in retaining plate 286 and is continuous with an aligned cylindrical opening 275A formed in top plate 282 of piston 242. Piston top plate 282 includes an extended bottom portion or spigot 277A in which cylindrical opening 275A is continuously formed. Cylindrical opening 275A provides a relatively longer cylindrical fluid path between bellows chamber 298 and piston chamber 299 than cylindrical openings 275 (FIGS. 3 and 4) and 275B (FIGS. 7 and 8), respectively. Openings 274A, 275A have a horizontal cross section with a generally circular shape but may have other shapes including oval, elliptical, polygonal or other shapes without changing the overall concept or operation of the present invention. Openings 274A and 275A cooperate to form a continuous asymmetrically shaped orifice 276A.

Turning now to FIGS. 7 and 8, first embodiment air spring 224 of the present invention is shown with alternatively configured or arranged openings. A conical shaped opening 274B is formed in retaining plate 286 and a portion of top plate 282 and is continuous with an aligned cylindrical opening 275B formed in top plate 282 of piston 242. Piston top plate 282 includes an extended bottom portion or spigot 277B in which cylindrical opening 275B is contiuously formed. Conical opening 274B provides a relatively longer conical fluid path than conical openings 274 (FIGS. 3 and 4) and 274A (FIGS. 5 and 6), respectively. Openings 274B, 275B have a horizontal cross section with a generally circular shape but may have other shapes including oval, elliptical, polygonal or other shapes without changing the overall concept or operation of the present invention. Openings 274B and 275B cooperate to form a continuous asymmetrically shaped orifice 276B.

Having now described the overall structure of first exemplary embodiment damping air spring 224 of the present invention, the operation of the damping air spring will now be described in detail below with respect to the configuration shown in FIGS. 3 and 4, with the understanding that the alternate configurations and arrangements shown in FIGS. 5 and 6 and FIGS. 7 and 8 demonstrate a similar type of function and result.

More specifically, when axle 32 of axle/suspension system 10 (FIG. 1), which is configured to incorporate first exemplary embodiment air spring 224 of the present invention, experiences a jounce event, such as when the vehicle wheels encounter a curb or a raised bump in the road, the axle moves vertically upwardly toward the vehicle chassis. In such a jounce event, bellows chamber 298 is compressed by axle/suspension system 10 (FIG. 1) as the wheels of the vehicle travel over the curb or the raised bump in the road. The compression of air spring bellows chamber 298 causes the internal pressure of the bellows chamber to increase. As a result, a pressure differential is created between bellows chamber 298 and piston chamber 299. This pressure differential causes air to flow from bellows chamber 298, through asymmetrical orifice 276, and into piston chamber 299. The restricted flow of air, between bellows chamber 298 and piston chamber 299 through asymmetrical orifice 276, causes damping to occur. As an additional result of the airflow through asymmetrical orifice 276, the pressure differential between bellows chamber 298 and piston chamber 299 is reduced. Air will continue to flow back and forth between piston chamber 299 to bellows chamber 298 through asymmetrical orifice 276 until the pressures in the piston chamber and the bellows chamber have equalized or pressure equilibrium has been reached between the piston and bellows chambers. When little or no suspension movement has occurred over a period of several seconds the pressure of bellows chamber 298 and piston chamber 299 can be considered equal.

Conversely, when axle 32 of axle/suspension system 10 (FIG. 1), which is configured to incorporate first exemplary embodiment air spring 224 of the present invention, experiences a rebound event, such as when the vehicle wheels encounter a large hole or depression in the road, the axle moves vertically downwardly away from the vehicle chassis. In such a rebound event, bellows chamber 298 is expanded by axle/suspension system 10 as the wheels of the vehicle travel into the hole or depression in the road. The expansion of air spring bellows chamber 298 causes the internal pressure of the bellows chamber to decrease. As a result, a pressure differential is created between bellows chamber 298 and piston chamber 299. This pressure differential causes air to flow from piston chamber 299, through asymmetrical orifice 276, and into bellows chamber 298. The restricted flow of air, between piston chamber 299 and bellows chamber 298 and through asymmetrical orifice 276, causes damping to occur. As an additional result of the airflow through asymmetrical orifice 276, the pressure differential between bellows chamber 298 and piston chamber 299 is reduced. Air will continue to flow back and forth between bellows chamber 298 and piston chamber 299 through asymmetrical orifice 276 until the pressures in the piston chamber and the bellows chamber have equalized or pressure equilibrium has been reached between the piston and bellows chambers. When little or no suspension movement has occurred over a period of several seconds the pressure of bellows chamber 298 and piston chamber 299 can be considered equal.

Because retaining plate opening 274 is conically shaped and top plate opening 275 is cylindrically shaped, they are generally asymmetrically shaped with respect to one another, and airflow from bellows chamber 298, through openings 274, 275 and into piston chamber 299 is generally less turbulent, thereby increasing airflow from the bellows chamber, through asymmetrical orifice 276 and into the piston chamber. Conversely, airflow from piston chamber 299 through asymmetrical orifice 276 into bellows chamber 298 is generally more turbulent, thereby decreasing airflow from the piston chamber into the bellows chamber. This asymmetrical flow of air within air spring 224 results in asymmetrical damping of the air spring as shown in FIG. 4A, with the amount of jounce or compression damping being generally reduced. This is desirable because it provides for a less harsh ride for the vehicle when it encounters raised bumps in the road, thereby reducing wear of the vehicle and its components.

Alternatively, by reversing the arrangement of openings 274 and 275, as shown in FIG. 4C at 274′ and 275′, so that opening 274′ is formed with a cylindrical shape and opening 275′ is formed with a conical shape, the opposite results are achieved. Because retaining plate opening 274′ is cylindrically shaped and top plate opening 275′ is conically shaped, they are generally asymmetrically shaped with respect to one another and form an asymmetrical orifice 276′, where airflow from bellows chamber 298, through openings 274′, 275′ and into piston chamber 299 is generally more turbulent, thereby decreasing airflow from the bellows chamber, through asymmetrical orifice 276′ and into the piston chamber. Conversely, airflow from piston chamber 299 through asymmetrical orifice 276′ into bellows chamber 298 is generally less turbulent, thereby increasing airflow from the piston chamber to the bellows chamber. This asymmetrical flow of air within air spring 224 results in asymmetrical damping of the air spring as shown in FIG. 4B, with the amount of rebound or expansion damping being generally reduced. This is desirable because it helps reduce the transient roll angle of the vehicle.

Openings 274A, 275A shown in FIG. 5 and openings 274B, 275B shown in FIGS. 7 and 8 demonstrate a type of function and result generally similar to the type of function and result accomplished by openings 274, 275. One distinction provided by openings 274A, 275A and 274B, 275B over openings 274, 275 is that each of cylindrical openings 275A, 275B further includes spigot 277A, 277B, respectively. Spigots 277A and 277B provide a generally longer length to openings 275A, 275B compared to cylindrical opening 275. As a result, asymmetrical orifices 276A, 276B exhibit a more turbulent airflow from piston chamber 299 to bellows chamber 298 than asymmetrical orifice 276 shown in FIG. 4. It is to be understood that openings 274A, 275A and 274B, 275B can be arranged in the opposite configuration, for example with openings 274A,275A formed in piston top plate 282 and openings 274B,275B and spigots 277A and 277B formed in retaining plate 286, without changing the overall concept or operation of the present invention.

Asymmetrically shaped orifices 276, 276A, 276B, and 276′ comprised of openings 274,275, 274A,275A, 274B, 275B, and 274′,275′, respectively, of first exemplary embodiment damping air spring 224 of the present invention promote asymmetrical damping of the air spring as set forth above. Asymmetrically shaped orifices 276A and 276B demonstrate asymmetrical damping as set forth in FIG. 4A.

First exemplary embodiment damping air spring 224 with asymmetrically shaped orifices 276, 276A, 276B, and 276′ comprised of openings 274,275, 274A,275A, 274B,275B, and 274′,275′, respectively, of the present invention overcomes the problems associated with prior art air spring 24 by eliminating the need for shock absorbers or allowing for the utilization of reduced size shock absorbers, thereby reducing complexity, saving weight and cost, and allowing the heavy-duty vehicle to haul more cargo. Moreover, elimination of the shock absorbers potentially eliminates costly repairs and/or maintenance costs associated with these systems.

First exemplary embodiment damping air spring 224 with asymmetrically shaped orifice 276, 276A, 276B, 276′ comprised of openings 274,275, 274A,275A, 274B, 275B, and 274′,275′, respectively, of the present invention also overcomes the problems associated with prior art air spring 124 with damping features by providing the asymmetrically shaped orifice between bellows chamber 298 and piston chamber 299 that provides asymmetrical airflow between the bellows chamber and the piston chamber, which results in asymmetrical damping of the air spring to improve application specific ride quality for the heavy-duty vehicle during operation. First exemplary embodiment damping air spring 224 of the present invention increases the ability to tune the amount of damping provided by the air spring for different applications, for example, by changing the size, shape and/or overall arrangement of asymmetrical orifice 276, 276A, 276B, 276′, the damping air spring of the present invention is able to provide asymmetrical damping for specific applications or conditions.

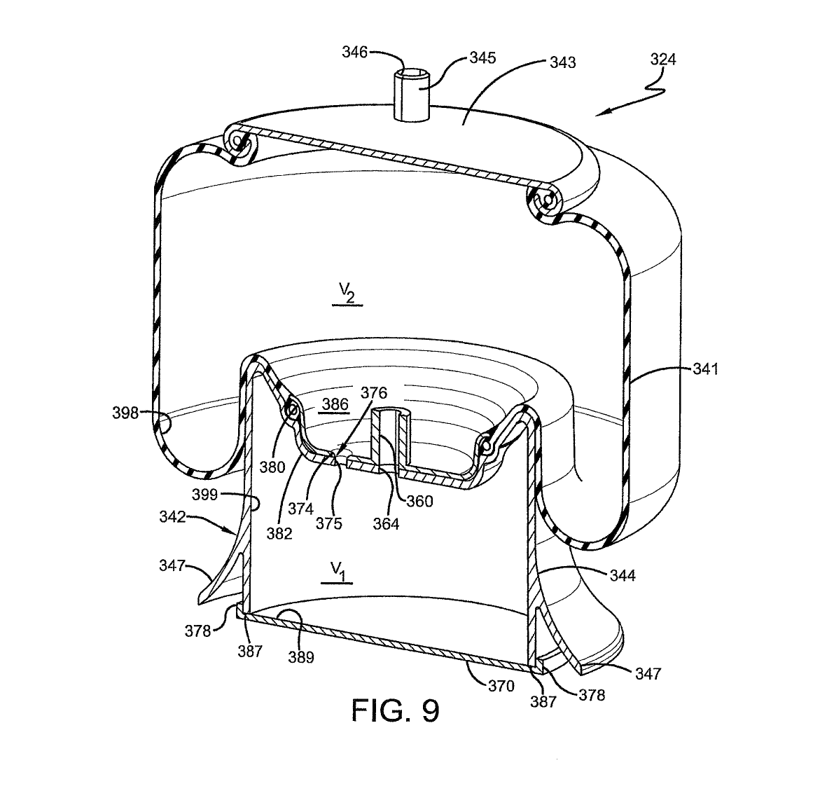

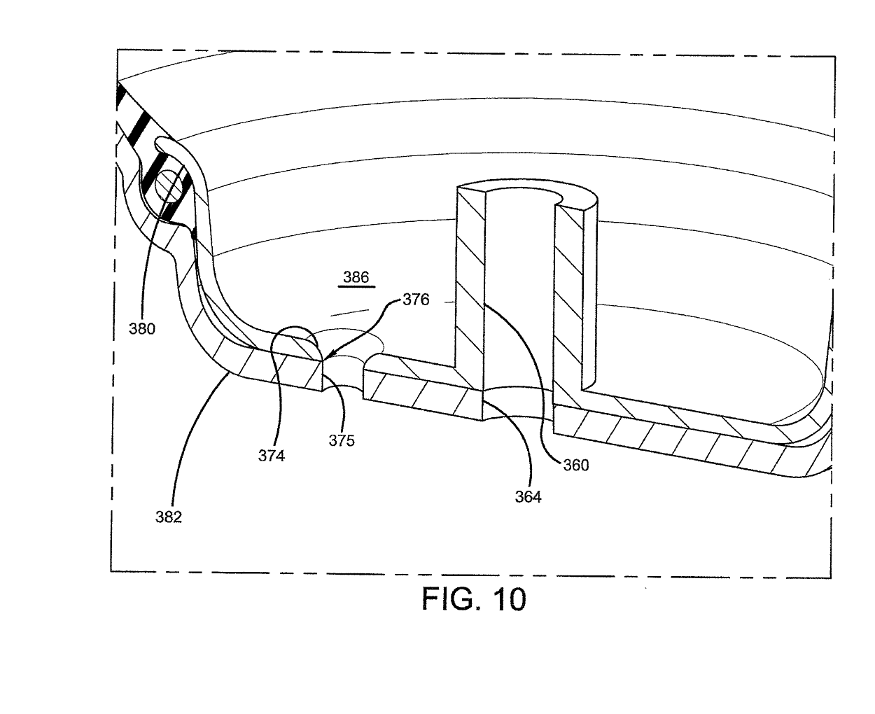

A second exemplary embodiment damping air spring with asymmetrically shaped orifice of the present invention is shown in FIGS. 9 and 10 at reference numeral 324 and will now be described in detail below.

Like prior art air springs 24 and 124, second exemplary embodiment air spring 324 of the present invention is incorporated into an axle/suspension system having a structure similar to axle/suspension system 10 (FIG. 1), or other air-ride axle/suspension system, but typically without shock absorbers. Air spring 324 includes a bellows 341, a bellows top plate 343, and a piston 342. Top plate 343 includes a pair of fasteners 345 (only one shown), each formed with an opening 346. Fasteners 345 are utilized to mount air spring 324 to an air spring plate (not shown), that in turn is mounted to the main member of the vehicle (not shown). It should be understood that fasteners 345 could also be utilized to mount air spring 324 directly to the main member of the vehicle (not shown), without changing the overall concept or operation of the present invention. Piston 342 is generally cylindrical-shaped and includes a sidewall 344, a flared portion 347, and a top plate 382.

With continued reference to FIGS. 9 and 10, a bumper (not shown) is disposed on a top surface of a retaining plate 386. The bumper (not shown) is formed from rubber, plastic or other compliant material and extends generally upwardly from retaining plate 386 mounted on the piston top plate 382. Retaining plate 386 and piston top plate 382 are each formed with an aligned opening 360, 364, respectively. A fastener (not shown), such as a bolt, is disposed through an opening formed in the bumper (not shown), retaining plate opening 360, and piston top plate opening 364. The bumper (not shown) and retaining plate 386 are mounted on the top surface of piston top plate 382 by the fastener (not shown). The bumper (not shown) serves as a cushion between piston top plate 382 and the underside of bellows top plate 343 in order to prevent the plates from damaging one another during operation of the vehicle. Retaining plate 386 includes a flared end 380 that is molded into the lower end of bellows 341, which holds the bellows in place on piston 342 and forms an airtight seal between the bellows and the piston. It should be understood that flared end 380 of retaining plate 386 could also be separate from the lower end of bellows 341. In such an arrangement, separate flared end 380 captures and holds the lower end of bellows 341 in place on piston 342 to form an airtight seal between the bellows and the piston, without changing the overall concept or operation of the present invention. Bellows 341, retaining plate 386, and bellows top plate 343 generally define a bellows chamber 398 having an interior volume V₂ at standard ride height. Bellows chamber 398 preferably has a volume of from about 305 in.³ to about 915 in.³. More preferably, bellows chamber 398 has a volume of about 485 in.³.

A generally circular disc 370 is attached or mated to the bottom of piston 342 of second exemplary embodiment damping air spring 324 of the present invention. Circular disc 370 is formed with an opening (not shown) for fastening piston 342 to beam rear end top plate 65 (FIG. 1) directly or utilizing a beam mounting pedestal (not shown) in order to attach piston 342 of air spring 324 to beam 18 (FIG. 1). Once attached, a top surface 389 of circular disc 370 is mated to a lowermost surface 387 of piston sidewall 344 to provide an airtight seal between the circular disc and piston 342. Circular disc 370 is formed with a continuous raised lip 378 on its top surface along the periphery of the circular disc, with the lip being disposed generally between flared portion 347 and sidewall 344 of piston 342 when the circular disc is mated to the piston. The attachment of circular disc 370 to piston 342 may be accomplished via fastening means such as a threaded fastener, other types of fasteners or the like. Optionally, the attachment of circular disc 370 to piston 342 may be supplemented by additional attachment means such as welding, soldering, crimping, friction welding, an O-ring, a gasket, adhesive or the like. Circular disc 370 may be composed of metal, plastic, and/or composite material, or other materials known to those skilled in the art, without changing the overall concept or operation of the present invention. Circular disc 370 may optionally include a groove (not shown) formed in top surface 389 disposed circumferentially around the circular disc, and configured to mate with a downwardly extending hub (not shown) of piston 342 in order to reinforce the connection of the circular disc to the bottom of the piston. An O-ring or gasket material could optionally be disposed in the groove to ensure an airtight fit of circular disc 370 to piston 342. Once circular disc 370 is attached to piston 342, top plate 382, sidewall 344, and the disc, define a piston chamber 399 having an interior volume V₁. Piston chamber 399 is generally able to withstand the required burst pressure of axle/suspension system 10 (FIG. 1) during vehicle operation. Piston chamber 399 preferably has a volume of from about 150 in.³ to about 550 in.³. More preferably, piston chamber 399 has a volume of about 240 in.³.

In accordance with one of the primary features of second embodiment air spring 324 of the present invention, a radiused opening 374 is formed in retaining plate 386 and is continuous with an aligned cylindrical opening 375 formed in top plate 382 of piston 342. Openings 374, 375 have a horizontal cross section with a generally circular shape but may have other shapes including oval, elliptical, polygonal or other shapes without changing the overall concept or operation of the present invention. Openings 374 and 375 cooperate to form a continuous asymmetrically shaped orifice 376.

Having now described the overall structure of second exemplary embodiment damping air spring 324 with asymmetrically shaped orifice 376 of the present invention, the operation of the damping air spring will now be described in detail below.

More specifically, when axle 32 (FIG. 1) of axle/suspension system 10 (FIG. 1), which is configured to incorporate second exemplary embodiment air spring 324 of the present invention, experiences a jounce event, such as when the vehicle wheels encounter a curb or a raised bump in the road, the axle moves vertically upwardly toward the vehicle chassis. In such a jounce event, bellows chamber 398 is compressed by axle/suspension system 10 (FIG. 1) as the wheels of the vehicle travel over the curb or the raised bump in the road. The compression of air spring bellows chamber 398 causes the internal pressure of the bellows chamber to increase. As a result, a pressure differential is created between bellows chamber 398 and piston chamber 399. This pressure differential causes air to flow from bellows chamber 398, through asymmetrical orifice 376, and into piston chamber 399. The restricted flow of air, between bellows chamber 398 and piston chamber 399 through asymmetrical orifice 376, causes damping to occur. As an additional result of the airflow through asymmetrical orifice 376, the pressure differential between bellows chamber 398 and piston chamber 399 is reduced. Air will continue to flow back and forth between piston chamber 399 and bellows chamber 398 through asymmetrical orifice 376 until the pressures in the piston chamber and the bellows chamber have equalized or pressure equilibrium has been reached between the piston and bellows chambers. When little or no suspension movement has occurred over a period of several seconds the pressure of bellows chamber 398 and piston chamber 399 can be considered equal.

Conversely, when axle 32 (FIG. 1) of axle/suspension system 10 (FIG. 1), which is configured incorporate second exemplary embodiment air spring 324 of the present invention, experiences a rebound event, such as when the vehicle wheels encounter a large hole or depression in the road, the axle moves vertically downwardly away from the vehicle chassis. In such a rebound event, bellows chamber 398 is expanded by axle/suspension system 10 as the wheels of the vehicle travel into the hole or depression in the road. The expansion of air spring bellows chamber 398 causes the internal pressure of the bellows chamber to decrease. As a result, a pressure differential is created between bellows chamber 398 and piston chamber 399. This pressure differential causes air to flow from piston chamber 399, through asymmetrical orifice 376, and into bellows chamber 398. The restricted flow of air, between piston chamber 399 and bellows chamber 398, and through asymmetrical orifice 376, causes damping to occur. As an additional result of the airflow through asymmetrical opening 376, the pressure differential between bellows chamber 398 and piston chamber 399 is reduced. Air will continue to flow back and forth between bellows chamber 398 and piston chamber 399 through asymmetrical orifice 376 until the pressures in the piston chamber and the bellows chamber have equalized or pressure equilibrium has been reached between the piston and bellows chambers. When little or no suspension movement has occurred over a period of several seconds the pressure of bellows chamber 398 and piston chamber 399 can be considered equal.

Because retaining plate opening 374 has a radiused cross-sectional shape and top plate opening 375 is cylindrically shaped, they are generally asymmetrically shaped with respect to one another, and airflow from bellows chamber 398, through openings 374, 375 and into piston chamber 399 is generally less turbulent, thereby increasing airflow from the bellows chamber, through asymmetrical orifice 376 and into the piston chamber. Conversely, airflow from piston chamber 399 through asymmetrical orifice 376 and into bellows chamber 398 is generally more turbulent, thereby decreasing airflow from the piston chamber into the bellows chamber. This asymmetrical flow of air within air spring 324 results in asymmetrical damping of the air spring as shown in FIG. 4A, with the amount of jounce or compression damping being generally reduced. This is desirable because it provides for a less harsh ride for the vehicle when it encounters raised bumps in the road, thereby reducing wear of the vehicle and its components. Asymmetrically shaped orifice 376, comprised of openings 374,375 of second exemplary embodiment damping air spring 324 of the present invention promotes asymmetrical damping of the air spring as set forth above.

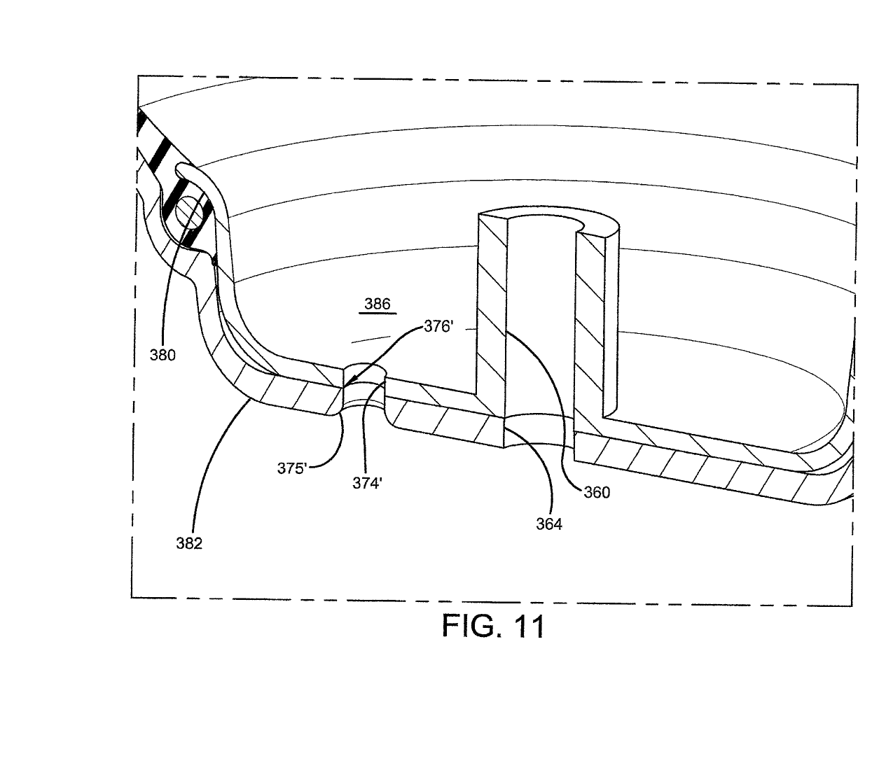

Alternatively, by reversing the arrangement of openings 374, 375, as shown in FIG. 11 at 374′ and 375, so that opening 374′ is formed with a cylindrical shape and opening 375′ is formed with a radiused shape, the opposite results are achieved. Because retaining plate opening 374′ is cylindrically shaped and top plate opening 375′ is radiusedly shaped, they are generally asymmetrically shaped with respect to one another and form an asymmetrical orifice 376′, where airflow from bellows chamber 298, through openings 374′, 375′ and into piston chamber 399 is generally more turbulent, thereby decreasing airflow from the bellows chamber, through asymmetrical orifice 376′ and into the piston chamber. Conversely, airflow from piston chamber 399, through asymmetrical orifice 376′ and into bellows chamber 398 is generally less turbulent, thereby increasing airflow from the piston chamber to the bellows chamber. This asymmetrical flow of air within air spring 324 results in asymmetrical damping of the air spring as shown in FIG. 4B, with the amount of rebound or expansion damping being generally reduced. This is desirable because it helps reduce the transient roll angle of the vehicle.

Asymmetrically shaped orifices 376 and 376′ comprised of openings 374,375 and 374′,375′, respectively, of second exemplary embodiment damping air spring 324 of the present invention promote asymmetrical damping of the air spring as set forth above.

Second exemplary embodiment damping air spring 324 with asymmetrically shaped orifices 376,376′ comprised of openings 374,375 and 374′,375′, respectively, of the present invention overcomes the problems associated with prior art air spring 24 by eliminating the need for shock absorbers or allowing for the utilization of reduced size shock absorbers, thereby reducing complexity, saving weight and cost, and allowing the heavy-duty vehicle to haul more cargo. Moreover, elimination of the shock absorbers potentially eliminates costly repairs and/or maintenance costs associated with these systems.

Second exemplary embodiment damping air spring 324 with asymmetrically shaped orifices 376,376′ comprised of openings 374,375 and 374′,375′, respectively, of the present invention also overcomes the problems associated with prior art air spring 124 with damping features by providing the asymmetrically shaped orifice between bellows chamber 398 and piston chamber 399 that provides asymmetrical airflow between the bellows chamber and the piston chamber, which results in asymmetrical damping of the air spring to improve application specific ride quality for the heavy-duty vehicle during operation. Second exemplary embodiment damping air spring 324 of the present invention increases the ability to tune the amount of damping provided by the air spring for different applications, for example, by changing the size, shape and/or overall arrangement of asymmetrical orifice 376, the damping air spring of the present invention is able to provide asymmetrical damping for specific applications and conditions.

It is contemplated that exemplary embodiment damping air springs 224,324 of the present invention could be utilized on tractor-trailers or heavy-duty vehicles, such as buses, trucks, trailers and the like, having one or more than one axle without changing the overall concept or operation of the present invention. It is further contemplated that exemplary embodiment damping air springs 224,324 of the present invention could be utilized on vehicles having frames or subframes which are moveable or non-movable without changing the overall concept or operation of the present invention. It is yet even further contemplated that exemplary embodiment damping air springs 224,324 of the present invention could be utilized on all types of air-ride leading and/or trailing arm beam-type axle/suspension system designs known to those skilled in the art without changing the overall concept or operation of the present invention. It is also contemplated that exemplary embodiment damping air springs 224,324 of the present invention could be utilized on axle/suspension systems having an overslung/top-mount configuration or an underslung/bottom-mount configuration, without changing the overall concept or operation of the present invention. It is also contemplated that exemplary embodiment damping air springs 224,324 of the present invention could be utilized in conjunction with other types of air-ride rigid beam-type axle/suspension systems such as those using U-bolts, U-bolt brackets/axle seats and the like, without changing the overall concept or operation of the present invention. It is further contemplated that exemplary embodiment damping air springs 224,324 of the present invention could be formed from various materials, including composites, metal and the like, without changing the overall concept or operation of the present invention. It is even contemplated that exemplary embodiment damping air springs 224,324 could be utilized in combination with prior art shock absorbers and other similar devices and the like, without changing the overall concept or operation of the present invention.

It is contemplated that discs 270,370 may be attached to pistons 242,342, respectively, utilizing other attachments such as soldering, coating, crimping, welding, snapping, screwing, O-ring, sonic, glue, press, melting, expandable sealant, press-fit, bolt, latch, spring, bond, laminate, tape, tack, adhesive, shrink fit, and/or any combination listed without changing the overall concept or operation of the present invention. It is even contemplated that discs 270,370 may be composed of materials known by those in the art other than metal, plastic, and/or composite material without changing the overall concept or operation of the present invention.

It is contemplated that exemplary embodiment damping air springs 224, 324 of the present invention could be utilized with all types of pistons having a piston chamber, without changing the overall concept or operation of the present invention. It is further contemplated that asymmetrically shaped openings 274,275, 274A,275A, 274B,275B, 274′,275′ and 374,375, 374′,375′ forming asymmetrically shaped orifices 276, 276A, 276B, 276′, and 376, 376′, respectively, of damping air springs 224, 324, respectively, could have other shapes and/or sizes, without changing the overall concept or operation of the present invention. It is also contemplated that asymmetrically shaped orifices 276, 276A, 276B, 276′ and 376, 376′ could be disposed at different locations within air springs 224,324, respectively, of the present invention, without changing the overall concept or operation of the present invention.

It is further contemplated that multiple asymmetrical orifices could be utilized in a single air spring, without changing the overall concept or operation of the present invention. It is even further contemplated that exemplary embodiment air springs 224,324 of the present invention could incorporate a remote air tank in place of piston chambers 299,399, without changing the overall concept or operation of the present invention.

In the foregoing description, certain terms have been used for brevity, clearness and understanding; but no unnecessary limitations are to be implied therefrom beyond the requirements of the prior art, because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the damping air spring with asymmetrically shaped orifice is used and installed, the characteristics of the construction, arrangement and method steps, and the advantageous, new and useful results obtained; the new and useful structures, devices, elements, arrangements, process, parts and combinations are set forth in the appended claims.

What is claimed is:

1. An air spring with damping characteristics for a suspension assembly of a heavy-duty vehicle comprising:
a bellows including a bellows chamber;
a piston including a piston chamber; and
an asymmetrical orifice in fluid communication with said bellows chamber and said piston chamber, wherein said asymmetrical orifice provides asymmetrical damping characteristics to said air spring of said heavy-duty vehicle.

2. The air spring with damping characteristics for a suspension assembly of a heavy-duty vehicle of claim 1, wherein said asymmetrical orifice includes a horizontal cross section comprising a shape chosen from the group consisting of a circle, an oval, an ellipse and a polygon.

3. The air spring with damping characteristics for a suspension assembly of a heavy-duty vehicle of claim 1, wherein said asymmetrically shaped orifice includes a conical opening adjacent to a cylindrical opening, said openings being aligned with one another.

4. The air spring with damping characteristics for a suspension assembly of a heavy-duty vehicle of claim 3, wherein said conical opening is formed in a retaining plate connected to said piston and said cylindrical opening is formed in a top plate of the piston of said air spring.

5. The air spring with damping characteristics for a suspension assembly of a heavy-duty vehicle of claim 3, wherein said conical opening is formed in a retaining plate and a portion of a top plate of said piston, and said cylindrical opening is formed in said top plate of the piston.

6. The air spring with damping characteristics for a suspension assembly of a heavy-duty vehicle of claim 1, wherein said asymmetrically shaped orifice includes a radiused opening and a cylindrical opening, said openings being aligned with one another.

7. The air spring with damping characteristics for a suspension assembly of a heavy-duty vehicle of claim 6, wherein said radiused opening is formed in a retaining plate connected to said piston and said cylindrical opening is formed in a top plate of the piston of said air spring.

8. The air spring with damping characteristics for a suspension assembly of a heavy-duty vehicle of claim 1, wherein said asymmetrical orifice includes a spigot.

9. The air spring with damping characteristics for a suspension assembly of a heavy-duty vehicle of claim 8, wherein said asymmetrical orifice further comprises a conical opening and a cylindrical opening, said openings being aligned with one another and with said spigot.

10. The air spring with damping characteristics for a suspension assembly of a heavy-duty vehicle of claim 8, wherein said asymmetrical orifice further comprises a radiused opening and a cylindrical opening, said openings being aligned with one another and with said spigot.

11. The air spring with damping characteristics for a suspension assembly of a heavy-duty vehicle of claim 1, wherein said piston chamber includes a volume of from about 150 in.³ to about 550 in.³.

12. The air spring with damping characteristics for a suspension assembly of a heavy-duty vehicle of claim 1, wherein said bellows chamber includes a volume of from about 305 in.³ to about 915 in.³.

13. The air spring with damping characteristics for a suspension assembly of a heavy-duty vehicle of claim 3, wherein said cylindrical opening is formed in a retaining plate connected to said piston and said conical opening is formed in a top plate of the piston of said air spring.

14. The air spring with damping characteristics for a suspension assembly of a heavy-duty vehicle of claim 6, wherein said cylindrical opening is formed in a retaining plate connected to said piston and said radiused opening is formed in a top plate of the piston of said air spring.
